(19) United States
(12) Patent Application Publication
(10) Pub. No.: US 2021/0206396 A1
(43) Pub. Date: Jul. 8, 2021

(54) SYSTEM, CONTROLLER AND METHOD CONTROLLING AUTONOMOUS VEHICLE FUNCTIONS

(71) Applicant: Bendix Commercial Vehicle Systems LLC, Elyria, OH (US)

(72) Inventors: Jeffrey M. Carbaugh, Lakewood, OH (US); David J. Taneyhill, Vermilion, OH (US)

(21) Appl. No.: 16/737,175

(22) Filed: Jan. 8, 2020

(51) Int. Cl. B60W 60/00; G05D 1/00; G05D 1/02

(52) U.S. Cl. CPC B60W 60/00184; B60W 30/16; G05D 1/0291; G05D 1/0088

(57) ABSTRACT

A controller for use with autonomous vehicle functions comprises an input for receiving data regarding a set of vehicle factors, an output for controlling autonomous vehicle functions and a processor having control logic. The control logic receives data regarding the set of vehicle factors, sets the autonomous vehicle functions in a first mode when at least two of the vehicle factors meet a respective first condition and sets the autonomous vehicle functions in second mode when at least one of the vehicle factors meets a respective second condition.

### BACKGROUND

The present invention relates to embodiments of a system, controller and method for controlling autonomous vehicle functions. Autonomous vehicle functions, such as platooning and lane keeping, are being evaluated and released on commercial vehicles. However, there are locations and times during a vehicle's operation when autonomous vehicle functions should be limited or not used at all. There is a need to improve how and when autonomous vehicle functions are enabled, or their use is restricted.

### SUMMARY

Various embodiments of an apparatus for controlling autonomous vehicle functions is disclosed. A vehicle controller according to one example of the invention comprises an input for receiving data regarding a set of vehicle factors, an output for controlling autonomous vehicle functions and a processor having control logic. The control logic receives data regarding the set of vehicle factors, sets the autonomous vehicle functions in a first mode when at least two of the vehicle factors meet a respective first condition and sets the autonomous vehicle functions in second mode when at least one of the vehicle factors meets a respective second condition.

In accordance with another aspect, various methods of controlling autonomous vehicle functions are disclosed. The method includes receiving data regarding at least one of a plurality of vehicle factors meeting at least two of respective first conditions; enabling autonomous vehicle functions in a first mode and setting the autonomous vehicle functions in a second mode in response to at least one of the plurality of vehicle factors meeting at least one of a respective second condition.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a vehicle having an autonomous function controller according to one example of the present invention.

FIG. 2 illustrates a method of controlling autonomous vehicle functions according to an example of the present invention.

### DETAILED DESCRIPTION

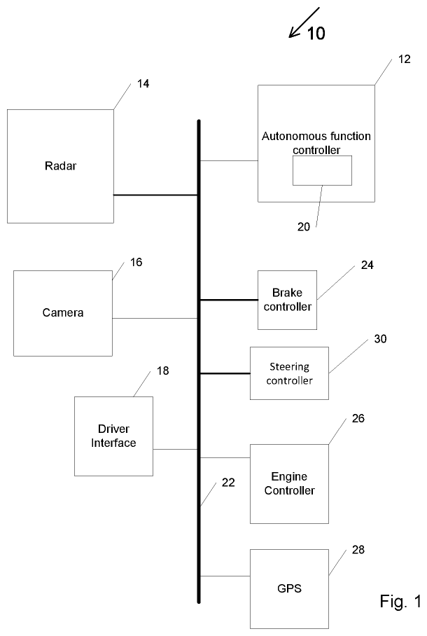

FIG. 1 illustrates a vehicle system 10 for an air braked vehicle that includes components for enabling and controlling autonomous vehicle functions. The system 10 includes at least one camera 16. The camera 16 may be a forward looking camera for viewing and analyzing the area in front of the vehicle. The video signals of camera 16 may be analyzed to detect an object's presence, size, longitudinal distance and lateral distance with respect to the vehicle. The camera 16 may include pedestrian identification and road sign recognition capabilities. Multiple cameras can be used on a single vehicle. The cameras can be mounted on the vehicle to detect, via image signal interpretation, multiple stationary or moving objects within a wide range to the front, side and rear of the vehicle.

The vehicle system 10 includes at least one radar 14, which may be a forward looking radar. The radar 14 transmits and receives radar signals, which are electromagnetic waves used to detect an object's presence, longitudinal distance, lateral distance, speed and direction with respect to the vehicle. The radar 14 can detect multiple stationary or moving objects within a wide range to the front and sides of the vehicle. Alternatively, a LIDAR, ultrasonic or other sensing device may be used.

The vehicle system 10 includes a brake controller 24. The brake controller 24 is responsive to sensors on the vehicle and transmits control signals to affect braking of the vehicle. The brake controller 24 may include anti-lock braking and stability control functions.

The vehicle system 10 includes a steering controller 30. The steering controller 30 is responsive to sensors on the vehicle and transmits control signals to affect the direction in which the vehicle is steered.

The vehicle system 10 includes a driver interface 18. The driver interface may be a warning lamp, an audible system, a display or other device, such as one that includes a haptic alert, that communicates additional information to the driver. The driver interface 18 may include an input for the driver to activate or deactivate a component or function of the vehicle system 10.

The vehicle system 10 includes an engine with engine controller 26. The engine controller 26 governs the vehicle speed. The vehicle speed information may be transmitted by the engine controller 26 to other controllers on the vehicle.

The vehicle system 10 includes a global positioning system (GPS) 28. The GPS 28 may be stand alone or may be integrated with another controller on the vehicle. The vehicle location may be transmitted by the GPS 28 to other controllers on the vehicle.

The vehicle system 10 includes a communications bus 22, which may use J1939 CAN or other protocol. Each of the components, such as the driver interface 18, brake controller 24, steering controller 30, engine controller 26 and GPS 28 of the vehicle system 10 may be connected to the communications bus 22.

The vehicle system 10 includes an autonomous function controller 12. The autonomous function controller 12 may perform autonomous or semi-autonomous vehicle functions, such as platooning, lane keeping, automatic emergency braking, adaptive cruise control, lane centering, automated steering control features and highway departure braking. The autonomous function controller 12 may perform braking functions for anti-lock braking and stability control, if integrated with the brake controller 24. The controller 12 includes a communications port for communicating with the vehicle communication bus 22. The controller 12 includes inputs for receiving the signals directly from the camera 16 and radar 14, or the controller 12 may receive the signals via the vehicle communication bus 22. The controller 12 may directly control the driver interface 18 or may transmit control signals and other information via the vehicle communication bus 22.

The controller 12 includes a processor with control logic 20 for interpreting the vehicle signals and other information from the vehicle communications bus 22 or directly from the other controllers or sensors on the vehicle. The control logic 20 communicates with a memory, which may include volatile memory, non-volatile memory, solid state memory, flash memory, random-access memory (RAM), read-only memory (ROM), electronic erasable programmable read-only memory (EEPROM), variants of the foregoing memory types, combinations thereof, and/or any other type(s) of memory suitable for providing the described functionality and/or storing computer-executable instructions for execution by the control logic 20. The control logic 20 includes a timer function.

The control logic 20 analyzes the information regarding different vehicle factors received from the camera 16, radar 14 and other sensors and controllers on the vehicle to determine if autonomous vehicle functions can be initiated and maintained. The control logic 20 receives the vehicle speed from wheel speed sensors or engine controller 26. In general, the signals regarding different vehicle factors must meet a predetermined condition in order to initiate and then maintain the autonomous vehicle functions. The autonomous vehicle functions may be initiated with full functionality, which can be a first mode, or each individually may be set to a reduced set of functionality, which can be a second mode, based on the vehicle factors. The reduced set of functionality may include disabling a particular autonomous vehicle function.

The control logic 20 may control the autonomous vehicle functions of the vehicle by transmitting signals to the steering controller 30, engine controller 26 and the brake controller 24. The control logic 20 may communicate the information from other sensors via the communications bus 22 for other vehicle systems to use in their decision-making process. The control logic 20 may communicate the mode in which the controller 12 is operating to the driver interface 18, for example.

Therefore, a controller comprises an input for receiving data regarding a set of vehicle factors, an output for controlling autonomous vehicle functions and a processor having control logic. The control logic receives data regarding the set of vehicle factors, sets the autonomous vehicle functions in a first mode when at least two of the vehicle factors meet a respective first condition and sets the autonomous vehicle functions in second mode when at least one of the vehicle factors meets a respective second condition.

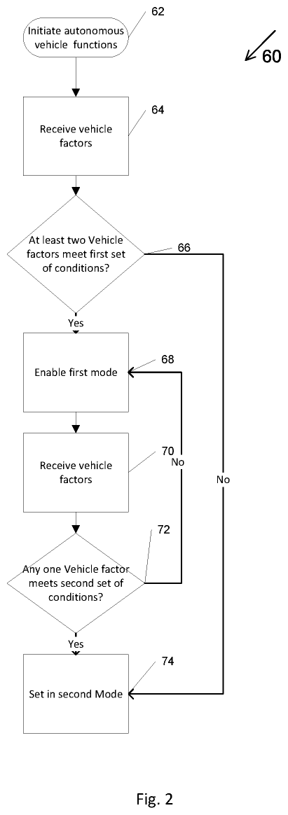

FIG. 2 illustrates a method 60 for controlling autonomous vehicle functions. The method 60 begins with step 62, when an autonomous vehicle function is initiated. The driver may indicate that he wants to begin using an autonomous vehicle function or the vehicle may determine that an autonomous vehicle function can be initiated automatically.

In step 64, the control logic 20 receives a set of vehicle factors. The vehicle factors include, for example, global positioning information, time, vehicle speed, road curvature and road speed sign interpretation. The vehicle factors are received from the camera 16, radar 14, GPS 28 and other controllers and sensors on the vehicle. The control logic 20 may receive raw data that needs to be interpreted by the control logic 20 or the data may be usable as received.

In step 66, the control logic 20 determines whether the set of vehicle factors meets a first set of conditions. Any combination of at least two of the vehicle factors must meet their respective first set of conditions. The first set of conditions include, but are not limited to, the following examples.

1) The GPS 28 indicates that the vehicle is in an autonomous vehicle function approved zone. The autonomous vehicle function approved zone may be defined by a municipality or may be defined by the vehicle owner.

2) A minimum time period has elapsed since any of the factors in the second set of factors (defined below) has occurred. The minimum time period may be between five minutes and ten minutes, for example.

3) The speed of the vehicle is within a predetermined range. The speed range may be between 35 mph and 55 mph, for example.

4) The road curvature is within a predetermined range. The road curvature may be determined by the camera 16 or the GPS 28. The road curvature may be between 500 feet and an infinite road curvature, for example.

5) The camera 16 or other sensor on the vehicle is able to interpret the road signs and the road signs do not prohibit autonomous vehicle functions. Some signs that may prohibit autonomous vehicle functions indicate a construction zone, a school zone or other indication that pedestrians are likely to be present. Speed signs indicating a speed greater than 35 mph, for example, may indicate an area is not prohibitive to autonomous vehicle functions. The camera 16, radar 14 or other vehicle sensor may also indicate no pedestrians are present in or around the path of travel of the vehicle.

6) If the driver did not manually initiate the request for the autonomous vehicle function, then the driver gives his consent for the autonomous vehicle function to begin through the driver information device 18.

If at least two of the vehicle factors do not meet their respective first set of conditions, the method 60 continues to step 74 where the autonomous vehicle functions are set to a second mode.

If at least two of the first set of conditions for each of the respective vehicle factors are met, the control logic 20 will set the vehicle in a first mode in step 68. The first mode enables all of the autonomous vehicle functions on the vehicle in a default setting. Certain human machine interface functions may be enabled, as well as endurance brake usage. The vehicle may automatically arrange the mirrors, displays and indicators. The first mode may also include enabling particular driver comfort features designed for longer range highway driving.

In step 70, the control logic 20 continues to receive the vehicle factors. In step 72, the control logic 20 reviews the vehicle factors against a second set of respective conditions. The control logic 20 determines if any one of the respective second set of conditions has been met. The second set of conditions include, but are not limited to, the following examples.

1) The GPS 28 indicates that the vehicle is not in an autonomous vehicle function approved zone.

2) A minimum time period has passed since any of the first set of factors has met the respective first condition. In one example, the minimum time period is between about three minutes and five minutes.

3) The speed of the vehicle is outside the predetermined range, whether going too slow or too fast.

4) The road curvature is outside the predetermined range.

5) The road signs indicate that pedestrians may be present, such as construction signs or pedestrian crossing signs.

6) The camera detects pedestrians to the front or sides of the host vehicle.

7) The driver disables the autonomous vehicle function through the driver interface 18.

If any one of the vehicle factors meets the respective second condition, the control logic 20 sets the autonomous vehicle functions in the second mode in step 74. The second mode may include enabling only collision mitigation and adaptive cruise control. In addition, the second mode can adjust thresholds from the default setting. For example, the second mode may include increasing the following distance between the vehicle and a target vehicle. If none of the respective second conditions are met, the method 60 returns to step 68 to allow the autonomous vehicle functions to continue in the first mode.

The method 60 can be repeated throughout the operation of vehicle as long as the autonomous vehicle function is initiated or desired.

Therefore, a method of controlling autonomous vehicle functions includes receiving data regarding at least one of a plurality of vehicle factors meeting all of a respective first condition, enabling autonomous vehicle functions in a first mode and setting the autonomous vehicle functions in a second mode in response to at least one of the plurality of vehicle factors meeting at least one of a respective second condition.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

We claim:

1. A vehicle controller for controlling autonomous vehicle functions comprising:
an input for receiving data regarding a set of vehicle factors;
an output for controlling autonomous vehicle functions; and
a processor having control logic, wherein the control logic
receives data regarding the set of vehicle factors at the input;
transmits a signal at the output to set the autonomous vehicle functions in a first mode when at least two of the vehicle factors meet a respective first condition; and
transmits a signal at the output to set the autonomous vehicle functions in second mode when at least one of the vehicle factors meets a respective second condition.

2. The vehicle controller as in claim 1, wherein the autonomous vehicle functions includes at least one of platooning, adaptive cruise control, lane keeping, automatic collision mitigation, lane centering, automated steering control and highway departure braking.

3. The vehicle controller as in claim 1, wherein the respective first condition of the vehicle factors includes a vehicle location in an approved zone, a minimum period of time since the respective second condition of vehicle factors was met, the speed of the vehicle being within a predetermined range, the road curvature being within a predetermined range, the road signs not prohibiting autonomous vehicle functions and the driver assenting to the operation of the autonomous vehicle function.

4. The vehicle controller as in claim 1, wherein the respective second condition of the vehicle factors includes a vehicle location not in an approved zone, the time being greater than a minimum time period since all of the first conditions were met, the speed of the vehicle being outside a predetermined range, the road curvature being outside a predetermined range, the road signs indicating pedestrians may be nearby and the driver overriding the operation of the autonomous vehicle function.

5. The vehicle controller as in claim 1, wherein the second mode increases the allowable following distance for the adaptive cruise control.

6. The vehicle controller as in claim 1, wherein the second mode disables at least one of the autonomous vehicle functions.

7. A method for controlling autonomous vehicle functions comprising:
receiving data regarding a plurality of vehicle factors meeting at least two of a respective first condition;
enabling autonomous vehicle functions in a first mode; and
setting the autonomous vehicle functions in a second mode in response to at least one of the plurality of vehicle factors meeting a respective second condition.

8. The method as in claim 7, wherein the plurality of vehicle factors include global positioning, time, vehicle speed, road curvature, road speed signs and the respective first condition includes the vehicle in an approved zone, the time greater than a minimum value since a second condition was met, the road curvature being inside a predetermined range, and the road speed signs stating an allowable speed greater a minimum.

9. The method as in claim 7, wherein the respective second condition includes the vehicle outside an approved zone, the time greater than a minimum value since all of the first conditions were met, the road curvature being outside a predetermined range, and the road speed signs stating an allowable speed less than a minimum speed.

10. The method as in claim 7, further comprising increasing the allowable following distance for the adaptive cruise control in the second mode.

11. The method as in claim 7, further comprising disabling at least one of the autonomous vehicle functions in the second mode.
